(19) United States
(12) Patent Application Publication
(10) Pub. No.: US 2022/0245745 A1
(43) Pub. Date: Aug. 4, 2022

(54) SYSTEM FOR SERVING LEGAL DOCUMENTS FOR INITIATING LEGAL PROCEEDINGS

(71) Applicant: ABC2 WEALTH & INVESTMENTS (PTY) LTD, Western Cape (ZA)

(72) Inventor: Jan Johannes Abraham DU PLOOY, Somerset West (ZA)

(21) Appl. No.: 17/624,743

(22) PCT Filed: Jul. 8, 2020
(86) PCT No.: PCT/ZA2020/050037

§ 371 Date: Jan. 4, 2022

(30) Foreign Application Priority Data
Jul. 8, 2019 (ZA) 2019/04449
Dec. 13, 2019 (ZA) 2019/08336
May 13, 2020 (ZA) 2020/02700

(51) Int. Cl. G06Q 50/18; G06Q 20/40; G06Q 20/38; G06Q 50/00

(52) U.S. Cl. CPC G06Q 50/18; G06Q 50/01; G06Q 20/3829; G06Q 20/40145

(57) ABSTRACT

A system for serving legal documents for initiating legal proceedings which includes a repository, the form of a database which is stored on a server (not shown), for receiving and storing legal documents for initiating legal proceedings, a notification means, in the form of a notifier, for notifying a recipient via an agreed digital address (not shown) of receipt by the database of a legal document, and a payment means (not shown) for allowing the recipient to access the legal document free of charge.

### TECHNICAL FIELD

This invention relates to a system for serving legal documents for initiating legal proceedings.

### SUMMARY OF THE INVENTION

According to the invention, there is provided a system for serving legal documents for initiating legal proceedings including: -

a repository for receiving and storing legal documents for initiating legal proceedings;

a notification means for notifying a recipient via an agreed digital address of receipt by the repository of a legal document; and

a payment means for allowing the recipient to access the legal document free of charge.

The repository may be located in and/or under the control of an authorised person for allowing the authorised person to effect electronic service of legal documents on recipients within its jurisdiction. The authorised person may be in the form of a sheriff. Communication means may be provided to allow communication with the repository by any legally appointed sheriff. The repository may be in the form of a database which may be stored on a server. The database may be in the form of a cloud-based database or may consist of a plurality of interconnected databases, preferably being interconnected in a P2P (Peer-to-Peer) network. The plurality of interconnected databases may be in the form of a distributed ledger which may be configured to utilize distributed ledger technology.

For the purposes of this specification, it is to be understood that a sheriff is an officer of the court who is responsible for serving court processes within the area of jurisdiction for which he has been appointed.

The notification means may further be configured to notify a sender of a legal document that the legal document has been received, viewed, accessed and/or retrieved by the recipient. The notification means may be in the form of a notifier which may be selected from the group including a pop-up message, message alert, short message service (SMS), multimedia messaging service (MMS), email, in-app message, link and hyperlink. The notifier may be received by a computing device of the recipient and/or sender of legal documents. The notification means may be storable in any suitable conventional read-only format so as to serve as irrefutable proof of service of the legal document on the recipient.

The notification means may be configured to operate using any suitable communication means of the group including the internet, Bluetooth, Wi-Fi, Zigbee, cellular network, telephone line, digital subscriber line (DSL), unstructured supplementary service data (USSD) and radio waves.

The notification means may be configured to notify the recipient via the agreed digital address of receipt by the repository of the legal document by prior agreement. The prior agreement may be in the form of a written agreement. The written agreement may include a clause wherein parties thereto agree that notification by the notification means of receipt by the repository of the legal document will constitute proper and effective service of the legal document on the recipient. The written agreement may include a clause relating to the specific jurisdiction of each party.

The recipient may be in the form of any one of the group including a plaintiff, applicant, respondent, defendant, sheriff, legal practitioner and candidate legal practitioner.

The legal document may be in the form of any one or more of the group including a summons, particulars of claim, pleadings, declaration, notice of motion, affidavit, letter of demand, writ, judgement and the like. The legal document may be in a read-only and/or an immutable format such as a pdf file or any other format that does not allow the legal document to be edited. It is to be appreciated that any changes made to any legal documents will be dated and time stamped.

The digital address may be in the form of any one or more of the group including an email address, registered subscriber identification module (SIM) number, social media handle, hash tag, mobile phone number, fax number and any other number that would serve as a digital address.

The sender may be a party to the prior agreement, in which the sender has agreed to effect service of legal documents on the recipient via its digital address. The sender may be in the form of any one of the group including a plaintiff, applicant, respondent, defendant, sheriff, legal practitioner and candidate legal practitioner.

For the purposes of this specification, it is to be understood that a social media handle is a username associated with a specific user, typically being linked to an online platform such as a social media website.

The computing device may be in the form of a device of group including a cellular phone, a smartphone, a computer, a tablet, a notepad, a wearable ancillary device, a server and the like. The computing device may include a global positioning system (GPS) for tracking a location of the recipient wherein a GPS location of the recipient may be utilised to ascertain the most suitable digital address via which to notify the recipient that a legal document addressed to it has been received by and may be retrieved from the repository.

A verification means may be arranged in communication with the repository for verifying an identity of the recipient and/or sender before allowing access to the repository. The verification means may be configured to allow the recipient and/or sender to input one or more unique identifying characteristics of the group including biometrical data, identity (ID) number, registered SIM number, tax number, email address, a code, a private key verified by a distributed ledger database and/or other contact details for comparison against stored unique identifying characteristics so as to verify an identity of the recipient and/or sender. The biometrical data may include fingerprint scans, facial scans, iris scans, headshot and/or the like. The stored unique identifying characteristics may have been obtained from the prior agreement to which the recipient and/or sender may be party. The input of unique identifying characteristics such as facial and/or iris scans may be performed by using a camera of the computing device of the recipient and/or sender. The input of unique identifying characteristics such as fingerprint scans may be performed by placing a finger or thumb of the recipient and/or sender onto a screen of the computing device of the recipient and/or sender. The verification means may be configured to receive the unique identifying characteristics inputted by the recipient and/or sender and may further convert and/or link the characteristics to biometrical data associated therewith for comparison with the stored biometrical data of the recipient and/or sender. Other identifying characteristics such as the ID and/or SIM number of the recipient and/or sender may be input using a keypad of the computing device of the recipient and/or sender.

An access means may be provided to the recipient and/or sender for allowing access to the repository without the need for further verification. In particular, the access means may be configured to permit viewing, downloading or uploading of legal documents on, from or to the repository. The access means may include an identifier which may be generated by the repository and/or computing device of the recipient and/or sender upon verification of the unique identifying characteristics provided by the recipient and/or sender. The identifier may serve to link the repository and the computing device of the recipient and/or sender. The identifier may be in the form of a randomly generated sequence of code specifically generated for the recipient and/or sender. This process is conventionally known as tokenising. The identifier may be received by the repository and/or computing device of the recipient and/or sender and may be sent back to the repository and/or computing device of the recipient and/or sender when the recipient and/or sender requires access to the repository. It is to be appreciated that upon receipt of the identifier, access to the repository may be allowed.

An uploading means may be arranged in communication with the repository for allowing a legal document to be uploaded to the repository. The uploading means may be in the form of a scanner which may be configured to covert a physical legal document into a digital legal document and upload it to the repository. The scanner may be in the form of any one or more of the group including a photocopier, a digital camera, a handheld scanner and the like. Alternatively, the uploading means may be in the form of a print to pdf function to convert a digital legal document to an immutable format which is accessible and/or readable by all parties. Alternatively, the uploading means may be in the form of a data transfer means for transferring a digital legal document from a data storage means to the repository. The data storage means may be in the form of any one or more of the group including an external hard drive or magnetic type hard drive, solid-state drive, network attached storage, flash or USB drive and an optical drive. The data storage means may form part of a computing device.

A downloading means may be arranged in communication with the repository for allowing the legal document to be retrieved and downloaded from the repository and stored on the computing device of the recipient, whereupon the legal document, preferably a copy thereof, may be stored and/or displayed on the computing device. It is to be appreciated that the original legal document remains on the repository, as well as immutable.

The payment means may be configured to utilize a toll free or a reverse billing system in order to allow gratuitous access or retrieval of the legal document by the recipient. The payment means may be further configured to allow payment of any costs pertaining to the legal document to be made by the recipient and/or sender, of the legal document.

A monitoring means may be provided for monitoring a degree of activity of the recipient on various social media platforms to ascertain the suitability of a particular digital address via which to notify the recipient that a legal document is available for retrieval from the repository.

An encryption means may be provided for encrypting all data and/or information communicated to or by the repository to the computing device of the recipient and/or sender.

Application software may be installed on the computing device of the recipient and/or sender and/or on the server for creating an interface between the computing device and the repository to allow a legal document to be uploaded to, retrieved and/or downloaded from the repository by the recipient and/or sender. The application software may be downloaded from any conventional online application software store. The payment means, verification means, the access means, the uploading means, the downloading means, the monitoring means and/or the encryption means may form part of the application software installed on the computing device of the recipient and/or sender and/or on the server. Alternatively, the payment means, verification means, the access means, the uploading means, the downloading means, the monitoring means and/or the encryption means may be in the form of an application programming interface (API) which may interface with the application software.

The application software may further include a recission application means for allowing a user to apply for recission of a judgement. The recission application means may be configured to generate an application for rescission of a judgement. The recission application means may be configured to allow a recipient of the judgement to upload an affidavit containing reasons in support of the application. The recission application means may be further configured to allow the recipient of the judgement to input details of the recipient's attorneys of record. The recission application means may include a sending means which may be configured to send the application for rescission of the judgement to the repository so that a sender of the judgement may retrieve the application from the repository.

### BRIEF DESCRIPTION OF THE DRAWING

A system for serving legal documents for initiating legal proceedings in accordance with the invention will now be described by way of the following, non-limiting examples with reference to the accompanying drawing.

In the drawing: -

FIG. 1 is a schematic showing a process diagram of a system for serving legal documents for initiating legal proceedings in accordance with the present invention.

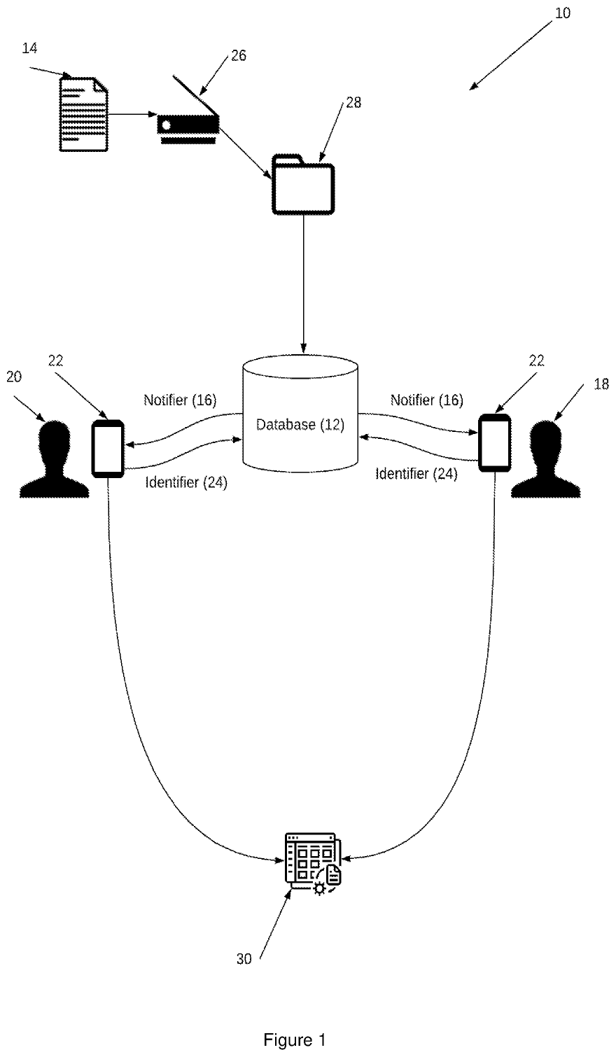

### DETAILED DESCRIPTION OF THE INVENTION

Referring now to the drawings reference numeral 10 refers generally to a system for serving legal documents for initiating legal proceedings which includes a repository, the form of a database 12 which is stored on a server (not shown), for receiving and storing legal documents 14 for initiating legal proceedings, a notification means, in the form of a notifier 16, for notifying a recipient 18 via an agreed digital address (not shown) of receipt by the database 12 of a legal document 14, and a payment means (not shown) for allowing the recipient 18 to access the legal document 14 free of charge.

The database 12 is located in or under the control of an authorised person (not shown) for allowing the authorised person (not shown) to effect electronic service of legal documents 14 on recipients 18 within its jurisdiction. The authorised person is in the form of a sheriff (not shown). Communication means (not shown) is provided to allow communication with the database 12 by any legally appointed sheriff (not shown). The database is in the form of a cloud-based database 12 or consists of a plurality of interconnected databases (not shown), typically being interconnected in a P2P (Peer-to-Peer) network (not shown). The plurality of interconnected databases (not shown) is in the form of a distributed ledger which is configured to utilize distributed ledger technology.

For the purposes of this specification, it is to be understood that a sheriff (not shown) is an officer of the court who is responsible for serving court processes within the area for which he has been appointed.

The notifier 16 is further configured to notify a sender 20 of a legal document 14 that the legal document 14 has been received, viewed, accessed or retrieved by the recipient 18. The notifier 16 is selected from the group including a pop-up message, message alert, short message service (SMS), multimedia messaging service (MMS), email, in-app message, link and hyperlink. The notifier 16 is received by a computing device 22 of the recipient 18 or sender 20 of legal documents 14. The notifier 16 is storable in any suitable conventional read-only format so as to serve as irrefutable proof of service of the legal document 14 on the recipient 18.

The notifier 16 is configured to operate using any suitable communication means of the group including the internet, Bluetooth, Wi-Fi, Zigbee, cellular network, telephone line, digital subscriber line (DSL), unstructured supplementary service data (USSD) and radio waves.

The notifier 16 is configured to notify the recipient 18 via the agreed digital address (not shown) of receipt by the database 12 of the legal document 14 by prior agreement (not shown). The prior agreement (not shown) is in the form of a written agreement. The written agreement (not shown) includes a clause wherein parties thereto agree that notification by the notifier 16 of receipt by the database 12 of the legal document 14 will constitute proper and effective service of the legal document 14 on the recipient 18. The written agreement (not shown) includes a clause relating to the specific jurisdiction of each party.

The recipient 18 is in the form of any one of the group including a plaintiff, applicant, respondent, defendant, sheriff, legal practitioner and candidate legal practitioner.

The legal document 14 is in the form of any one or more of the group including a summons, particulars of claim, pleadings, declaration, notice of motion, affidavit, letter of demand, writ, judgement and the like. The legal document 14 is in a read-only or an immutable format such as a pdf file or any other format that does not allow the legal document 14 to be edited. It is to be appreciated that any changes made to any legal documents 14 will be dated and time stamped.

The digital address (not shown) is in the form of any one or more of the group including an email address, registered subscriber identification module (SIM) number, social media handle, hash tag, mobile phone number, fax number and any other number that would serve as a digital address.

The sender 20 is a party to the agreement (not shown), in which the sender 20 has agreed to effect service of legal documents 14 on the recipient 18 via its digital address (not shown). The sender 20 is in the form of any one of the group including a plaintiff, applicant, respondent, defendant, sheriff, legal practitioner and candidate legal practitioner.

For the purposes of this specification, it is to be understood that a social media handle is a username associated with a specific user, typically being linked to an online platform such as a social media website.

The computing device 22 is in the form of a device of group including a cellular phone, a smartphone, a computer, a tablet, a notepad, a wearable ancillary device, a server and the like. The computing device 22 includes a global positioning system (GPS) (not shown) for tracking a location of the recipient 18 wherein a GPS location of the recipient 18 is utilised to ascertain the most suitable digital address (not shown) via which to notify the recipient 18 that a legal document 14 addressed to it has been received by and may be retrieved from the database 12.

A verification means arranged in communication with the database 12 for verifying an identity of the recipient 18 or sender 20 before allowing access to the database 12. The verification means is configured to allow the recipient 18 or sender 20 to input one or more unique identifying characteristics of the group including biometrical data, identity (ID) number, registered SIM number, tax number, email address, a code, a private key verified by a distributed ledger database or other contact details for comparison against stored unique identifying characteristics so as to verify an identity of the recipient 18 or sender 20. The biometrical data (not shown) includes fingerprint scans, facial scans, iris scans, headshot or the like. The stored unique identifying characteristics have been obtained from the agreement (not shown) to which the recipient 18 and sender 20 are party. The input of unique identifying characteristics such as facial and iris scans is performed by using a camera (not shown) of the computing device 22 of the recipient 18 or sender 22. The input of unique identifying characteristics such as fingerprint scans are performed by placing a finger or thumb of the recipient 18 or sender 22 onto a screen (not shown) of the computing device 22 of the recipient 18 or sender 20. The verification means is configured to receive the unique identifying characteristics inputted by the recipient 18 or sender 20 and further convert or link the characteristics to biometrical data (not shown) associated therewith for comparison with the stored biometrical data (not shown) of the recipient 18 or sender 20. Other identifying characteristics such as the ID and SIM number of the recipient 18 or sender 20 is input using a keypad (not shown) of the computing device 22 of the recipient 18 or sender 20.

An access means is provided to the recipient 18 or sender 20 for allowing access to the database 12 without the need for further verification. In particular, the access means is configured to permit viewing, downloading or uploading of legal documents 14 on, from or to the database 12. The access means includes an identifier 24 which is generated by the database 12 or computing device 22 of the recipient 18 or sender 20 upon verification of the unique identifying characteristics provided by the recipient 18 or sender 20. The identifier 24 serves to link the database 12 and the computing device 22 of the recipient 18 or sender 20. The identifier 24 is in the form of a randomly generated sequence of code specifically generated for the recipient 18 or sender 20. This process is conventionally known as tokenising. The identifier is received by the database 12 or computing device of the recipient or sender and may be sent back to the database 12 or computing device 22 the recipient 18 or sender 20 when the recipient 18 or sender 20 requires access to the database 12. It is to be appreciated that upon receipt of the identifier 24, access to the database 12 is allowed.

An uploading means is arranged in communication with the database 12 for allowing a legal document 14 to be uploaded to the database 12. The uploading means is in the form of a scanner 26 which may be configured to covert a physical legal document 14 into a digital legal document 28 and upload it to the database 12. The scanner 26 is in the form of any one or more of the group including a photocopier, a digital camera, a handheld scanner and the like. Alternatively, the uploading means is in the form of a print to pdf function (not shown) to convert a digital legal document 28 to an immutable format which is accessible or readable by all parties. Alternatively, the uploading means is in the form of a data transfer means for transferring a digital legal document 28 from a data storage means to the database 12. The data storage means may is the form of any one or more of the group including an external hard drive or magnetic type hard drive, solid-state drive, network attached storage, flash or USB drive and an optical drive. The data storage means forms part of a computing device (not shown).

A downloading means is arranged in communication with the database 12 for allowing the legal document 14 to be retrieved and downloaded from the database 12 and stored on the computing device 22 of the recipient 18, whereupon the legal document 14, typically a copy thereof, is stored and displayed on the computing device 22. It is to be appreciated that the original legal document 14 remains on the database, as well as immutable.

The payment means is configured to utilize a toll free or a reverse billing system (not shown) in order to allow gratuitous access or retrieval of the legal document 14 by the recipient 18. The payment means is further configured to allow payment of any costs pertaining to the legal document 14 to be made by the recipient 18 or sender 20, of the legal document 14.

A monitoring means is further provided for monitoring a degree of activity of the recipient 18 on various social media platforms to ascertain the suitability of a particular digital address (not shown) via which to notify the recipient 18 that a legal document 14 is available for retrieval from the database 12.

An encryption means is provided for encrypting all data and information communicated to or by the database 12 to the computing device 22 of the recipient 18 or sender 20.

Application software 30 is installed on the computing device 22 of the recipient 18 or sender 20 or on the server (not shown) for creating an interface between the computing device 22 and the database 12 to allow a legal document 14 to be uploaded to, retrieved or downloaded from the database 12 by the recipient 18 or sender 20. The application software 30 is downloaded from any conventional online application software store (not shown). The payment means, the verification means, the access means, the uploading means, the downloading means, the monitoring means and the encryption means forms part of the application software 30 installed on the computing device 22 of the recipient 18 or sender 20 or on the server (not shown). Alternatively, the payment means, verification means, the access means, the uploading means, the downloading means, the monitoring means and the encryption means are in the form of an application programming interface (API) (not shown) which interfaces with the application software 30.

The application software 30 further includes a recission application means for allowing a user to apply for recission of a judgement. The recission application means is configured to generate an application for rescission of a judgement. The recission application means is configured to allow a recipient 18 of the judgement to upload an affidavit containing reasons in support of the application. The recission application means is further configured to allow the recipient 18 of the judgement to input details of the recipient's attorneys of record. The recission application means includes a sending means which is configured to send the application for rescission of the judgement to the database 12 so that a sender 20 of the judgement may retrieve the application from the database 12.

In use, a sender 20 of a physical legal document 14 makes use of a scanner 26 to convert the physical legal document 14 into a digital legal document 28 and upload in to the database 12. Alternatively, the digital legal document 28 is transferred from a data storage means to the database 12. Once the sender 20 of the legal document 14 has uploaded it to the database 12, the database 12 will send a notifier 16 to the computing device 22 of a recipient 18 of the legal document 14, notifying the recipient 18 that the legal document 14 has been received by the database 12 via a digital address (not shown) of the recipient 18. The recipient 18 having agreed, in an agreement (not shown), to receive such legal document 14 via his digital address (not shown) and that such notification will constitute proper and effective service of the legal document 14 on the recipient 18. The computing device 22 of the recipient 22 sends an identifier 24 to the database and upon receipt of the identifier the database 12 allows the recipient 18 to view and/or download the legal documents 14 from the database 12. Once the recipient 18 has retrieved the legal document 14, the database 12 sends a notifier 16 to a computing device 22 of the sender 20 to notify the sender 20 of the legal document 14 that the legal document 14 has been received and retrieved by the recipient 18. The notifier 16 is then stored on the computing device 22 of the sender 20 in any suitable conventional read-only format so as to serve as irrefutable proof of service of the legal document 14 on the recipient 18.

It is, of course, to be appreciated that the system for serving legal documents for initiating legal proceedings in accordance with the invention is not limited to the precise constructional and functional details as hereinbefore described with reference to the accompanying drawings and which may be varied as desired.

Although only certain embodiments of the invention have been described herein, it will be understood by any person skilled in the art that other modifications, variations, and possibilities of the invention are possible. Such modifications, variations and possibilities are therefore to be considered as falling within the spirit and scope of the invention and hence form part of the invention as herein described and/or exemplified. It is further to be understood that the examples are provided for illustrating the invention further and to assist a person skilled in the art with understanding the invention and is not meant to be construed as unduly limiting the reasonable scope of the invention.

The inventor believes that the system for serving legal documents for initiating legal proceedings in accordance with the present invention is advantageous in that it allows for digital or electronic service of legal documents issued by a court on persons having no or difficult to find physical addresses. Currently, most people have a cellular phone or other computing devices and therefore a digital address which by way of the current invention allows for these digital addresses to be used as a person's physical address. Serving of legal documents can therefore be performed remotely. In this way the need for a sheriff to travel to physical address becomes obsolete. The present system thus provides a safer, cost effective and easier way of serving legal documents issued by a court on persons whom service is to be effected.

1. A system for serving legal documents for initiating legal proceedings which includes: -
a repository for receiving and storing legal documents for initiating legal proceedings;
a notification means for notifying a recipient via an agreed digital address of receipt by the repository of a legal document; and
a payment means for allowing the recipient to access the legal document free of charge.

2. A system as claimed in claim 1 wherein the repository is located in or under the control of an authorised person for allowing the authorised person to effect electronic service of legal documents on recipients within its jurisdiction.

3. A system as claimed in claim 1 wherein communication means is provided to allow communication with the repository by any legally appointed sheriff.

4. A system as claimed in claim 1 wherein the notification means is further configured to notify a sender of a legal document that the legal document has been received, viewed, accessed or retrieved by the recipient.

5. A system as claimed in claim 1 wherein the notification means is in the form of a notifier which is selected from the group including a pop-up message, message alert, short message service (SMS), multimedia messaging service (MMS), email, in-app message, link, and hyperlink.

6. A system as claimed in claim 5 wherein the notifier is received by a computing device of the recipient or sender of legal documents.

7. A system as claimed in claim 1 wherein the notification means is storable in any suitable conventional read-only format so as to serve as irrefutable proof of service of the legal document on the recipient.

8. A system as claimed in claim 1 wherein the notification means is configured to operate using any suitable communication means of the group including the internet, Bluetooth, Wi-Fi, Zigbee, cellular network, telephone line, digital subscriber line (DSL), unstructured supplementary service data (USSD), and radio waves.

9. A system as claimed in claim 1 wherein the recipient is in the form of any one of the group including a plaintiff, applicant, respondent, defendant, sheriff, legal practitioner and candidate legal practitioner.

10. A system as claimed in claim 1 wherein the legal document is in the form of any one or more of the group including a summons, particulars of claim, pleadings, declaration, notice of motion, affidavit, letter of demand, writ, judgement and the like.

11. A system as claimed in claim 1 wherein the digital address is in the form of any one or more of the group including an email address, registered subscriber identification module (SIM) number, social media handle, hash tag, mobile phone number, fax number and any other number that would serve as a digital address.

12. A system as claimed in claim 1 wherein a verification means is arranged in communication with the repository for verifying an identity of a recipient or sender of a legal document before allowing access to the repository.

13. A system as claimed in claim 12 wherein the verification means is configured to allow the recipient or sender to input one or more unique identifying characteristics of the group including biometrical data, identity (ID) number, registered SIM number, tax number, email address, a code, a private key verified by a distributed ledger database and other contact details for comparison against stored unique identifying characteristics so as to verify an identity of the recipient or sender.

14. A system as claimed in claim 1 wherein an access means is provided to a recipient or sender of a legal document for allowing access to the repository without the need for further verification, wherein the access means is configured to permit viewing, downloading or uploading of legal documents on, from or to the repository.

15. A system as claimed in claim 1 wherein the payment means is configured to utilize a toll free or a reverse billing system in order to allow gratuitous access or retrieval of the legal document by the recipient.

16. A system as claimed in claim 1 wherein a monitoring means is provided for monitoring a degree of activity of the recipient on various social media platforms to ascertain the suitability of a particular digital address via which to notify the recipient that a legal document is available for retrieval from the repository.

17. A system as claimed in claim 6 wherein application software is installed on the computing device of the recipient or sender or on a server for creating an interface between the computing device and the repository to allow a legal document to be uploaded to, retrieved or downloaded from the repository by the recipient or sender.

18. (canceled)

19. A system as claimed in claim 18 wherein the application software further includes a recission application means for allowing a user to apply for recission of a judgement.

20. A system as claimed in claim 19 wherein the recission application means is configured to generate an application for rescission of a judgement.

21. A system as claimed in claim 1 wherein the notification means is configured to notify the recipient via the agreed digital address of receipt by the repository of the legal document by prior agreement.
